(19) United States
(12) Patent Application Publication
(10) Pub. No.: US 2026/0139116 A1
(43) Pub. Date: May 21, 2026

(54) METHOD FOR RECYCLING A USED POLYAMIDE COMPOSITION

(71) Applicant: ARKEMA FRANCE, Puteaux (FR)

(72) Inventors: Geoffroy CAMMAGE, Serquigny (FR); Charlotte HERDT, Serquigny (FR); Marjorie MARCOURT, Serquigny (FR); Guillaume LE, Serquigny (FR)

(73) Assignee: ARKEMA FRANCE, Puteaux (FR)

(21) Appl. No.: 19/118,486

(22) PCT Filed: Oct. 5, 2023
(86) PCT No.: PCT/FR2023/051555

§ 371 Date: Apr. 4, 2025

(30) Foreign Application Priority Data
Oct. 5, 2022 (FR) FR2210209

(51) Int. Cl. C08J 11/08; B29B 17/02; B29C 64/153; B29K 77/00; B29K 105/26; B33Y 10/00; B33Y 70/00; C09D 5/03; C09D 177/02

(52) U.S. Cl. CPC C08J 11/08; B29B 17/02; B33Y 70/00; C09D 5/031; C09D 177/02; B29B 2017/0293; B29C 64/153; B29K 2077/00; B29K 2105/26; B33Y 10/00; C08J 2377/02

(57) ABSTRACT

A process for recycling a used polyamide composition into a recycled polyamide powder having a monomodal melting endotherm and a single melting temperature (T_{f1}^{max}), said process including the steps of: i. placing a used polyamide composition in contact with a solvent so as to obtain a mixture; ii. heating the mixture so as to dissolve the polyamide in the solvent; iii. cooling the mixture to the precipitation temperature (Tₚ) of the polyamide in the solvent, thereby obtaining a precipitated polyamide powder characterized by a non-monomodal melting endotherm and more than one melting temperature, (T_{f1}^{max}) being the highest melting temperature; iv. maintaining the temperature of the mixture at a temperature at most equal to Tₚ, notably in the range from Tₚ −0.1° C. to Tₚ −15° C., until the precipitated polyamide powder is characterized by a monomodal melting endotherm and a melting temperature (T_{f1}^{max}); and v. recovery of the recycled polyamide powder obtained.

### FIELD OF THE INVENTION

The present invention relates to a process for recycling a used polyamide composition into a polyamide powder having an increased difference between the melting temperature and the crystallization temperature (T_{f1}−T_{c}) of the polyamide powder.

A large difference between T_{f1} and T_{c} of a polyamide-based powder is useful in many applications, notably in the technology of powder agglomeration via melting or sintering induced by radiation, for instance a laser beam (laser sintering), infrared radiation or UV radiation, or any source of electromagnetic radiation which allows the powder to be melted in order to manufacture objects.

The present invention also relates to the polyamide powders obtained according to this process.

Finally, the invention relates to the use of this powder and to the articles manufactured therefrom.

### PRIOR ART

The technology of agglomerating polyamide powders under a laser beam is used to manufacture three-dimensional objects such as prototypes and models in various fields.

A thin layer of polyamide powder is deposited on a horizontal plate maintained in a chamber heated to a temperature lying between the crystallization temperature Tc and the melting temperature T_{f1} of the polyamide powder. The laser agglomerates the powder particles at different points in the powder layer according to a geometry corresponding to the object, for example using a computer having, in its memory, the shape of the object and reproducing this shape in the form of slices. The powder zones exposed to the laser solidify as soon as their temperature falls below the crystallization temperature T_{c}. Subsequently, the horizontal plate is lowered by a distance corresponding to the thickness of a powder layer, a new powder layer is then deposited and the laser agglomerates the powder particles according to a geometry corresponding to this new slice of the object, and so on. The procedure is repeated until the entire object has been manufactured. An object surrounded by non-agglomerated powder is obtained inside the chamber. The assembly is then slowly cooled.

After complete cooling, the object is separated from the powder, which can be reused for another operation.

Immediately after the action of the laser beam, the temperature of the exposed zone is higher than the crystallization temperature (T_{c}) of the powder. However, when the temperature falls too quickly below this temperature, for example by applying a new, cooler layer of powder, this causes deformations in the part being printed (which is known as “curling”). Similarly, when the temperature of the powder in the machine comes too close to the melting temperature (T_{f1}) of the powder, this leads to solidification around the parts (which is known as “caking”), which is manifested by the formation of lumps of powder that affect the printing quality.

To avoid these phenomena, it is thus important to have powders with a temperature T_{c} as far away as possible from the T_{f1} of the powder. The difference T_{f1}−T_{c} of the powder determines the working temperature window of the device used to agglomerate the powder particles by radiation-induced melting. This working window is defined by its upper temperature limit and its lower temperature limit. The upper limit of the working window corresponds to the temperature at which agglomeration or “caking” takes place. The lower limit of the working window corresponds to the temperature at which distortion or deformation or “curling” occurs. It is desirable for this working window to be greater than the variation in temperature within 3D printing machines, which is generally of the order of ±3° C.

Moreover, a high heat of fusion (ΔH_{f}) is advantageous so as to optimize the geometrical definition of the manufactured parts. Specifically, if it is too low, the energy supplied by the laser runs the risk of sintering, by thermal conduction, the powder particles surrounding the part undergoing construction, which limits the geometrical precision of the part obtained. It is clear that all that has just been explained regarding the agglomeration of polyamide powders under a laser beam is valid regardless of the electromagnetic radiation that brings about fusion, and whether the fusion process is selective or non-selective.

U.S. Pat. No. 5,932,687 discloses a process for preparing a precipitated polyamide powder having a narrow particle distribution and low porosity. This process comprises a first step of cooling the polyamide previously dissolved in an alcohol solvent to a temperature T₁ (higher than the precipitation temperature of the polyamide in the solvent) in order to obtain germination of the polyamide, followed by a second cooling step in order to obtain supersaturation of the medium and thus precipitation of the polyamide at a temperature T₂. The suspension obtained is directly cooled and dried to recover the polyamide powder.

US 2008/0166496 discloses a polyamide 11 powder that may be used in a powder agglomeration process, notably to prepare three-dimensional objects. These powders are prepared according to a process comprising a step of cooling the polyamide previously dissolved in ethanol to a temperature at which the polyamide precipitates. The heat generated by the precipitation keeps the medium at this temperature for 25 minutes, then the temperature reduces slightly and a 35-minute isotherm is achieved. At the end of this steady stage, the mixture is cooled to isolate the precipitated polyamide powder.

However, the inventors were able to observe that the processes of the prior art afforded polyamide powders whose analysis by differential scanning calorimetry on first heating showed the presence of two temperature peaks, associated with two relatively close but different melting temperatures, revealing the presence of at least two distinct crystal phases. For the reasons mentioned previously, this heterogeneity of the thermal characteristics of the powder reduces the working window and is thus potentially detrimental to the quality of the objects manufactured according to the process of powder agglomeration via electromagnetic radiation-mediated fusion, notably to their definition.

These processes relate to the preparation of virgin polyamide powders.

As mentioned, the technology described produces a large amount of powder which is not agglomerated but is impaired due to the fact that it has been subjected to a temperature close to T_{f1} for a substantial period of time. It is advantageous to recycle these powders so as to limit the energy and resource consumption. Processes for recycling polyamides contained in used compositions, notably derived from 3D printing waste, have been described.

Thus, CN110483986 describes a process for recycling residual polyamide 12 powder after selective laser sintering. This process involves dissolving the powder to be recycled in an acidic solution and then neutralizing and atomizing this solution to obtain a recycled polyamide powder. This process, which is specific to the treatment of 3D printing waste, thus involves treatment in an acidic medium, which is very aggressive toward the polyamide. It also does not allow the polyamide to be separated from the other products present in the composition, and does not allow the physicochemical features of the recycled polyamide powder to be controlled, notably its viscosity, particle size or thermal characteristics. Also, it requires specific equipment and the management of the acidic solution streams makes it particularly cumbersome to implement.

CN 109810284 describes a process for dissolving polyamide 12 waste from 3D printing, by means of a composite solvent system comprising a mixture of hydrochloric, formic and acetic acid. A solid/liquid separation step is performed at elevated temperature before precipitating the polyamide by adding water as a non-solvent. However, this dissolution/precipitation process in an acidic medium is very aggressive toward the polyamide and does not allow control of the physicochemical features of the recycled powder either. Moreover, the management of the acidic solution streams also makes this process cumbersome to implement.

There is thus a real need for a process for recycling used polyamide compositions into a recycled polyamide powder, which is notably useful for technologies of powder agglomeration via electromagnetic radiation-mediated fusion, allowing these drawbacks to be overcome.

### SUMMARY OF THE INVENTION

The inventors have now developed a dissolution/precipitation process which allows used polyamide compositions to be recycled and which also effectively increases the difference T_{f1}−T_{c} of the recycled polyamides, by obtaining a monomodal melting endotherm.

More particularly, it was found that by introducing, at the end of the polyamide precipitation phase, a temperature steady stage of sufficient duration, it was possible to convert a precipitated polyamide powder characterized by a non-monomodal melting endotherm and more than one melting temperature (T_{f1}), (T_{f1}^{max}) being the highest melting temperature, into a polyamide powder characterized by a monomodal melting endotherm and a single melting temperature (Tf₁) equal to (T_{f1}^{max}), and thus to increase the temperature difference (T_{f1}−T_{c}). The inventors were notably able to demonstrate that this temperature steady stage allowed crystal refinement to take place, and thus a single crystal phase to be obtained.

The polyamide powders obtained are thus particularly advantageous for use in a process of powder agglomeration via electromagnetic radiation-mediated fusion, notably in that they allow the working window to be widened and thus the quality and/or definition of the objects manufactured from these powders to be improved.

According to yet other advantages, the recycling process according to the invention is easy to perform and does not require the use of acidic conditions. It also allows the particle size of the powder to be controlled, notably its span factor, and the polyamide to be separated, at least partially, from the other compounds present in the used composition, such as additives and fillers. The recycling process thus allows a recycled polyamide powder to be obtained with a high degree of purity, the thermal features of which are improved relative to those of the used polyamide.

Thus, according to a first aspect, the object of the invention is thus to provide a process for recycling a used polyamide composition into a recycled polyamide powder having a monomodal melting endotherm and a single melting temperature (T_{f1}^{max}), said process comprising the steps of:
i. placing a used polyamide composition in contact with a solvent so as to obtain a mixture;
ii. heating the mixture so as to dissolve the polyamide in the solvent;
iii. cooling the mixture to the precipitation temperature (Tₚ) of the polyamide in said solvent, thereby obtaining a precipitated polyamide powder characterized by a non-monomodal melting endotherm and more than one melting temperature, (T_{f1}^{max}) being the highest melting temperature; and
iv. maintaining the temperature of the mixture at a temperature at most equal to Tₚ, notably in the range from Tₚ −0.1° C. to Tₚ −15° C., until the precipitated polyamide powder is characterized by a monomodal melting endotherm and a melting temperature (T_{f1}^{max}); and
v. recovery of the recycled polyamide powder obtained.

Advantageously, the process also has one or more of the following features. Thus, in certain embodiments, the process according to the invention is a process:
in which the solvent which is placed in contact with the polyamide is an alcohol, in particular a C₁-C₄ aliphatic alcohol, preferably ethanol;
in which the heating of the mixture is performed at a temperature of from 100° C. to 200° C., and preferably from 120° C. to 160° C.; and/or in which the heating of the mixture has a duration of from 1 to 6 hours, and preferably from 1 to 3 hours;
in which the cooling of the mixture in step iii) is performed at a rate of from 1° C. to 100° C. per hour and preferably from 10° C. to 60° C. per hour;
in which the polyamide is polyamide 11, polyamide 6, or polyamide 10.10, or polyamide 10.12, or polyamide 6.10;
in which the precipitation temperature Tₚ of the polyamide is between 80° C. and 130° C., notably between 100 and 120° C.;
in which, in step iv), the mixture is maintained at a temperature close to the precipitation temperature for a period of at least 2 hours, notably between 3 and 12 hours, with effect from the start of precipitation of the polyamide;
also comprising a step vi) of drying the precipitated polyamide powder recovered in step v) or obtained on conclusion of step iv), notably at a temperature of between 10° C. and 150° C., more particularly between 50 and 100° C.;
in which the drying of the precipitated polyamide powder is performed at a pressure ranging from 10 mbar to atmospheric pressure;
in which the composition also comprises volatile organic compounds (VOCs);
in which the composition comprises mineral fillers, notably fibers, in particular glass and/or carbon fibers; and/or
also comprising a step vii) of separating and recovering the mineral fillers that may be present in the precipitated polyamide powder, notably after step iv), v) or vi).

According to a second aspect, an object of the present invention is also to provide a polyamide powder having a monomodal melting endotherm and a single melting temperature (T_{f1}^{max}) that can be obtained via the recycling process according to the invention.

Advantageously, the powder has one or more of the following features. Thus, in certain embodiments, the powder according to the invention is a polyamide powder:
characterized in that it has a volume-mean diameter of between 10 and 200 μm, notably between 20 and 100 μm, and preferentially between 40 and 80 μm;
characterized in that it has a diameter Dv10 of greater than 5 μm, notably between 10 and 70 μm, and preferentially between 20 and 60 μm;
characterized in that it has a diameter Dv90 of less than 350 μm, notably between 30 and 200 μm, and preferentially between 50 and 150 μm;
characterized in that it has a median diameter Dv50 of between 10 and 200 μm, notably between 20 and 100 μm, and preferentially between 30 and 90 μm;
characterized in that it has a span factor of between 0.1 and 1.5; preferably between 0.1 and 1.0 and more preferentially between 0.5 and 1.0;
in which the polyamide is polyamide 11;
characterized in that it has a melting temperature (T_{f1}^{max}) of between 195 and 205° C.; and/or
in which the difference between the melting temperature (T_{f1}^{max}) and the crystallization temperature (T_{c}) is between 35 and 45° C.
According to a third aspect, the invention relates to a polyamide 11 powder having a monomodal melting endotherm and a single melting temperature (T_{f1}^{max}) of between 195° C. and 205° C., also having at least one of the following features:
a volume-mean diameter of between 10 and 200 μm, notably between 20 and 100 μm, and preferentially between 40 and 80 μm;
a diameter Dv10 of greater than 5 μm, notably between 10 and 70 μm, and preferentially between 20 and 60 μm;
a volume-median diameter Dv50 of between 10 and 200 μm, notably between 20 and 100 μm, and preferentially between 30 and 90 μm;
a diameter Dv90 of less than 350 μm, notably between 30 and 200 μm, and preferentially between 50 and 150 μm;
a span factor of between 0.1 and 1.5; preferably between 0.1 and 1 and more preferentially between 0.5 and 1.0;
an enthalpy of fusion of greater than 100 J/g; and preferentially between 110 and 160 J/g; and/or
an inherent viscosity of between 0.8 and 1.8, and preferentially between 1.0 and 1.5.

According to a fourth aspect, a subject of the invention is a composition in powder form for 3D printing, notably by laser sintering, comprising:
a polyamide powder according to the invention; and
at least one filler or additive.

According to a fifth aspect, the invention relates to a process for manufacturing polyamide objects by powder agglomeration via electromagnetic radiation-mediated fusion, the powder being as defined previously.

According to a sixth aspect, the invention relates to a manufactured article obtained by electromagnetic radiation-mediated fusion of a powder or a composition according to the invention.

According to a seventh aspect, a subject of the invention is the use of a process according to the invention for increasing the difference (T_{f1}−T_{c}) between the melting temperature (T_{f1}) and the crystallization temperature (T_{c}) of a polyamide.

According to an eighth aspect, the invention relates to recycled mineral fillers which may be obtained according to the recycling process according to the invention.

According to one embodiment, the recycled mineral fillers are precoated with a polyamide powder having a monomodal melting endotherm and a single melting temperature, which may be obtained via the recycling process according to the invention.

### FIGURES

FIG. 1 represents an image obtained by scanning electron microscopy (SEM) (magnification ×120) of glass fibers, precoated with PA11, obtained on conclusion of the process according to inventive example 1.

FIG. 2 represents an image obtained by scanning electron microscopy (SEM) (magnification ×240) of carbon fibers, precoated with PA11, obtained on conclusion of the process according to inventive example 2.

### DETAILED DESCRIPTION

The invention is now described in greater detail and in a nonlimiting manner in the description that follows.

### Definitions

It is pointed out that the expressions “from . . . to . . . ” and “between . . . and . . . ” used in the present description should be understood as including each of the limits mentioned. The term “used polyamide powder composition” means a composition in powder form containing a polyamide optionally in combination with other constituents, notably including additives or fillers, resulting from industrial transformation of a polyamide-based composition, for example by extrusion, molding, typically by injection, or else by 3D printing. It may notably be a composition derived from used finished products, or from production scraps or waste generated during the process for transforming the polyamide-based composition.

These used compositions are generally characterized by a partial degradation of the macromolecular chain of the polyamide, which may be in a partially oxidized form and thus include imide and/or alcohol and/or primary amide functions which did not exist on the virgin polyamide (before conversion and any possibly use). Also, the polyamides are combined with other constituents such as stabilizers, which may themselves have undergone degradation. The recycling process according to the invention advantageously allows the polyamide in the used compositions to be separated from the other constituents, producing a virtually pure polyamide powder.

The term “powder” is understood to denote a solid material in finely divided form; which is generally provided in the form of particles of very small size, generally of the order of a few hundred micrometers or less.

The powders are generally characterized by thermograms obtained by Differential Scanning Calorimetry (DSC) according to:
a first heating, allowing the melting of the polyamide powder to be characterized;
cooling, allowing the crystallization of the polyamide material to be characterized;
a second heating, allowing the melting of the polyamide material itself to be characterized.

The following terms, in connection with the thermal properties, are understood as defined in the standard ISO 11357-1: 2016:
a “peak” refers to the portion of the thermogram obtained by differential scanning calorimetry (DSC) which deviates from the baseline to reach a local maximum or a local minimum and which then returns to the baseline. Such a peak may indicate a first-order transition (crystallization exotherm or melting endotherm); a melting peak, for the purposes of the present description, may notably comprise several peaks or shoulders before the signal returns to the baseline.
a “baseline” denotes the part of the recorded thermogram without any transition, notably in this case without any first-order transition of melting or crystallization type. In a transition zone, a virtual baseline can be determined: this is an imaginary line plotted through the transition zone, it being assumed that the heat due to the transition is zero. The virtual baseline may be plotted by interpolating the baseline of the specimen by means of a straight line;
a “peak area” denotes the area delimited by the peak and the interpolated virtual baseline. It is regarded as an enthalpy of transition, expressed in J/g. The term “enthalpy of fusion” is understood to mean the heat necessary to melt the composition, corresponding to the area under the melting peak(s) on the thermogram, measured according to the standard ISO 11357-3: 2018.

The term “melting temperature” is understood to denote the representative temperature of the melting phenomenon during which the at least partially crystalline polyamide powder or polyamide material passes into the viscous liquid state, as measured according to the standard ISO 11357-3: 2018. Unless otherwise indicated, this is more particularly the temperature corresponding to the maximum intensity of the melting peak measured by DSC. Thus, for the purposes of the present description, a melting peak, which would comprise several peaks or shoulders, would be associated with several melting temperatures, namely one melting temperature for each peak or shoulder.

The term “melting temperatures on first and second heating” means melting temperatures, noted respectively T_{f1} for first heating and T_{f2} for second heating, measured by DSC, according to the standard ISO 11357-3: 2018, and corresponding respectively to the maximum signal intensity of the melting peak on first heating and on second heating, both performed with a temperature ramp of 20° C./min. Thus, for the purposes of the present description, if several melting temperatures (Tf₁) are detected on first heating, then the one to be used for calculating the difference (T_{f1}−T_{c}) is the T_{f1} temperature corresponding to the lowest melting temperature, namely Tf₁^{min}. Tf₁^{max} denotes the highest melting temperature (Tf₁) and corresponds to the only melting temperature (Tf₁) obtained on conclusion of step iv).

The term “crystallization temperature”, denoted Tc hereinbelow, means the temperature at which the at least partially crystalline compound passes from the viscous liquid state to the semicrystalline state as measured according to the standard ISO 11357-3: 2018, with a temperature ramp of −20° C./min. The crystallization temperature corresponds more particularly to that measured during cooling after the first melting of the compound (first heating) and before the second melting (second heating), the first melting allowing the thermal history of the compound to be erased. Unless otherwise indicated, this is the temperature of the crystallization peak, corresponding to the maximum intensity of the DSC signal. Thus, for the purposes of the present description, if several crystallization temperatures are detected on cooling, then T_{c} corresponds to the highest crystallization temperature and it is this value that must be used for calculating the difference (T_{f1}−T_{c}). The term “monomodal melting endotherm” of the polyamide powder means the part of the thermogram obtained by differential scanning calorimetry (DSC) corresponding to the first melting of the polyamide powder, and which is characterized by a single melting temperature Tf₁. In other words, the melting peak corresponding to the first heating comprises one and only one peak. In contrast, a multimodal melting endotherm is characterized by a melting peak on first heating having several peaks, i.e. several melting peak temperatures. Similarly, a melting endotherm whose melting peak on first heating has a shoulder would not be considered as a monomodal endotherm for the purposes of the present description.

The term “precipitation temperature”, denoted Tₚ hereinbelow, means the temperature at which the mixture formed by the polyamide and the solvent used in the process changes from a homogeneous state to a heterogeneous state. The precipitation temperature is detected using a temperature sensor (PT100 type) coupled with a dynamic thermoregulation system (for example, a “petite fleur” system sold by the company Huber). At the time of precipitation, there is a strong spontaneous contribution of thermal energy (exothermicity) that the thermoregulation system may not be able to compensate for instantaneously. By IT means, the precipitation temperature can be accurately detected by plotting the derivative of the temperature of the reaction medium as a function of time. The value of this derivative is equal to the cooling rate programmed by means of the thermoregulation system before and after the precipitation phenomenon: the exothermicity induces a perturbation in the derivative which allows it to be detected. The temperature corresponding to the start of the perturbation of the derivative is regarded as the precipitation temperature (Tₚ).

The term “Dv50” means the powder particle volume-median diameter value such that the cumulative volume-weighted particle diameter distribution function is equal to 50%. Similarly, “Dv10” and “Dv90” are, respectively, the corresponding diameters such that the cumulative volume-weighted particle diameter function is equal to 10% and, respectively, to 90%. These values are measured according to the standard ISO 13319-1: 2021, for example using a Coulter Counter Multisizer 3 particle size analyzer. The rules for the representation of results of a particle size distribution are given by the standard ISO 9276—parts 1 to 6.

The term “span factor” means a factor characterizing the width of the particle size distribution, defined as: span=(Dv90−Dv10)/Dv50, the diameters “Dv10”, “Dv50” and “Dv90” being as defined previously.

The term “mean diameter” means the value of the volume-mean diameter of the particles corresponding to the volume-weighted arithmetic mean of the particle diameters. This value is measured according to the standard ISO 13319-1: 2021, for example using a Coulter Counter Multisizer 3 particle size analyzer.

The term “viscosity” denotes the inherent viscosity as measured in a viscometer of Ubbelohde type according to the standard ISO 307: 2019, except for using m-cresol as solvent and a temperature of 20° C. The inherent viscosity has the dimension of the inverse of a concentration and is equal to the natural logarithm of the relative viscosity, all divided by the concentration of polymer dissolved in the solvent.

The term “3D printing” denotes a technique directed toward producing parts by additive manufacturing, by selectively melting a powder by means of electromagnetic radiation, such as a laser or infrared light.

The term “VOC” means a volatile organic compound, i.e. an organic compound having a vapor pressure of 0.01 kPa or more at a temperature of 293.15 K, or having a corresponding volatility under the particular conditions of use. The most commonly known are butane, toluene, ethanol (90° alcohol), acetone and benzene.

### Process for Recycling a Used Polyamide Composition

According to a first aspect, the object of the invention is thus to provide a process for recycling a used polyamide composition into a recycled polyamide powder having a monomodal melting endotherm and a single melting temperature (T_{f1}^{max}), said process comprising the steps of:
i. placing a used polyamide composition in contact with a solvent so as to obtain a mixture;
ii. heating the mixture so as to dissolve the polyamide in the solvent;
iii. cooling the mixture to the precipitation temperature (Tₚ) of the polyamide in said solvent, thereby obtaining a precipitated polyamide powder characterized by a non-monomodal melting endotherm and more than one melting temperature, (T_{f1}^{max}) being the highest melting temperature; and
iv. maintaining the temperature of the mixture at a temperature at most equal to Tₚ, notably in the range from Tₚ −0.1° C. to Tₚ −15° C., until the precipitated polyamide powder is characterized by a monomodal melting endotherm and a melting temperature (T_{f1}^{max}); and
v. recovery of the recycled polyamide powder obtained.

In the following description, the term “monomer” should be taken as meaning a “repeating unit”. The case where a repeating unit consists of the combination of a diamine with a diacid is particular. It is considered that it is the combination of a diamine and of a diacid, i.e. the diamine.diacid pair, which corresponds to the monomer. This is explained by the fact that, individually, the diamine or diacid does not allow amide-type functions to be obtained.

For the purposes of the invention the term “polyamide” means the condensation products of lactams, amino acids or diamine.diacid couples. It may be a homopolymer, i.e. a polymer resulting from the condensation of the same repeating unit, i.e. the same monomer, or a copolymer resulting from the condensation of at least two repeating units, i.e. two different monomers, called “co-monomers”, i.e. at least one monomer and at least one co-monomer (monomer different from the first monomer) to form a copolymer such as a copolyamide (abbreviated as CoPA), as defined hereinbelow.

The term “copolyamide” (abbreviated as CoPA) means the polymerization products of at least two different monomers chosen from:
monomers of amino acid or aminocarboxylic acid type, and preferably α, ω-aminocarboxylic acids;
monomers of lactam type;
pairs of monomers of the “diamine.diacid” type resulting from the reaction between a diamine and a dicarboxylic acid; and
mixtures thereof, with monomers containing a different carbon number in the case of mixtures between a monomer of amino acid type and a monomer of lactam type.

These monomers may be linear or branched or substituted, where appropriate.

According to certain embodiments, the polyamide is a homopolymer.

According to a first type, the polyamide is derived from the condensation of an aliphatic, cycloaliphatic or aromatic dicarboxylic acid, notably containing from 4 to 36 carbon atoms, preferably from 6 to 18 carbon atoms, and an aliphatic, cycloaliphatic or aromatic diamine, notably containing from 2 to 20 carbon atoms, preferably from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM), 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, the polyamide is chosen from PA 4.6, PA 4.10, PA 4.12, PA 4.14, PA 4.18, PA 6.10, PA 6.12, PA 6.14, PA 6.18, PA 9.12, PA 10.10, PA 10.12, PA 10.14 and PA 10.18. In the notation PA X. Y, X represents the number of carbon atoms derived from the diamine residues and Y represents the number of carbon atoms derived from the diacid residues, as is conventional.

In certain embodiments, the polyamide is chosen from polyamide 11, polyamide 6, polyamide 10.10, polyamide 10.12, or polyamide 6.10. Preferably, the polyamide is PA 11.

### Steps i) and ii)

The indefinite article “a” or the definite article “the” before the term “polyamide” used in the process according to the invention means, in the context of the present description, “at least one polyamide”, and respectively “said at least one polyamide”.

Thus, in a first step i), a used polyamide composition, i.e. a used composition comprising “at least one” polyamide, is placed in contact with a solvent so as to obtain a mixture.

Preferably, only one polyamide is used in the process.

It is however possible to use a mixture of several, notably two polyamides. Preferably, such a mixture comprises a predominant polyamide, notably representing more than 80% by weight of the total weight of polyamides used in step i), so as to obtain coprecipitation of the polyamide mixture.

In certain embodiments, the solvent which is placed in contact with the polyamide may be chosen from: ethanol, propanol, butanol, isopropanol, heptanol, formic acid, acetic acid, N-methylpyrrolidone, N-butylpyrrolidone, butyrolactam, caprolactam.

Preferably, the solvent which is placed in contact with the polyamide is a C₁-C₄ aliphatic alcohol, more preferentially ethanol, and even more preferably technical grade ethanol of 96% purity (containing water and denatured with 2-butanone and propan-2-ol).

The polyamide may have a weight fraction in the solvent of from 0.01 to 0.30; and preferably from 0.1 to 0.3. In particular, it may have a weight fraction of 0.01 to 0.05; 0.05 to 0.1; or 0.1 to 0.15 or 0.15 to 0.2; or 0.2 to 0.25; or 0.25 to 0.3.

The mixture obtained is then heated in step ii) to dissolve the polyamide, i.e. until a homogeneous mixture is obtained.

Heating of the mixture may notably be performed at a temperature of between 100° C. and 180° C., and preferably between 120° C. and 160° C.

In certain embodiments, heating of the mixture may for example be performed at a temperature of from 100° C. to 105° C.; or from 105° C. to 110° C.; or from 110° C. to 115° C.; or from 115° C. to 120° C.; or from 120° C. to 125° C.; or from 125° C. to 130° C.; or from 130° C. to 135° C.; or from 135° C. to 140° C.; or from 140° C. to 145° C.; or from 145° C. to 150° C.; or from 150° C. to 155° C.; or from 155° C. to 160° C.; or from 160° C. to 165° C.; or from 165° C. to 170° C.; or from 170° C. to 175° C.; or from 175° C. to 180° C.; or from 180° C. to 185° C.; or from 185° C. to 190° C.; or from 190° C. to 195° C.; or from 195° C. to 200° C.

In certain embodiments, the heating of the mixture, notably maintenance of the mixture at the dissolution temperature, may have a duration of from 1 to 6 hours, and preferably from 1 to 3 hours. Thus, the heating of the mixture may last from 1 hour to 1 hour and 30 minutes; or from 1 hour and 30 minutes to 2 hours; or from 2 hours to 2 hours and 30 minutes; or from 2 hours and 30 minutes to 3 hours; or from 3 hours to 3 hours and 30 minutes; or from 3 hours and 30 minutes to 4 hours; or from 4 hours to 4 hours and 30 minutes; or from 4hours and 30 minutes to 5 hours; or from 5 hours to 5 hours and 30 minutes; or from 5 hours and 30 minutes to 6 hours.

In certain embodiments, the heating comprises at least one step in which the temperature is increased to reach a maximum temperature of between 100° C. and 200° C., in particular between 120° C. and 160° C.

In certain embodiments, the heating comprises at least one step in which the temperature remains essentially constant at a value of between 100° C. and 200° C., in particular between 120° C. and 160° C.

### Step iii)

Next, in step iii), the mixture is cooled so as to precipitate the polyamide in the form of a powder.

The precipitation temperature (Tₚ) may vary, for the same polyamide, as a function of the solvent. Similarly, for the same solvent, it may vary as a function of the polyamide. Specifically, the precipitation of the polyamide is accompanied by a release of heat leading to a slight rise in the internal temperature. At the end of precipitation, no more heat is released and the internal temperature drops back to its nominal temperature.

This precipitation temperature may be between 80° C. and 130° C., notably between 100 and 120° C., in particular when the solvent is a C₁-C₄ aliphatic alcohol.

This cooling may be performed down to a temperature greater than or equal to 50° C. Thus, for example, cooling may be performed down to a temperature of 50° C. Thus, for example, cooling may be performed to a temperature ranging from 50° C. to 60° C.; or from 60° C. to 70° C.; or from 70° C. to 80° C.; or from 80° C. to 90° C.; or from 90° C. to 100° C.; or from 100° C. to 110° C.; or from 110° C. to 120° C.; or from 120° C. to 130° C.

Furthermore, this cooling may be performed at a rate of between 1 and 100° C. per hour, preferably between 10 and 60° C. per hour, and more preferably between 20 and 50° C. per hour. For example, cooling may be performed at a rate of 1 to 5° C. per hour; 5 to 10° C. per hour; 10 to 15° C. per hour; or 15 to 20° C. per hour; or 20 to 25° C. per hour; or 25 to 30° C. per hour; or 30 to 35° C. per hour; or 35 to 40° C. per hour; or 40 to 45° C. per hour; or from 45 to 50° C. per hour; or from 50 to 55° C. per hour; or from 55 to 60° C. per hour; or from 60 to 65° C. per hour; or from 65 to 70° C. per hour; or from 70 to 75° C. per hour; or from 75 to 80° C. per hour; or from 80 to 85° C. per hour; or from 85 to 90° C. per hour; or from 90 to 95° C. per hour; or from 95 to 100° C. per hour.

In certain embodiments, and in order to promote precipitation, an amount of polyamide may be introduced in step i) of loading the starting materials. Preferably, this amount of polyamide is less than or equal to 20% by mass, and preferably less than or equal to 10% by mass relative to the total mass of polyamide used in step i). The polyamide may be identical to or different from that dissolved in the solvent, preferably identical. The polyamide may notably be chosen from polyamide 11, polyamide 6, polyamide 10.10, polyamide 10.12 and polyamide 6.10.

Thus, the added amount of polyamide may represent from 0.1% to 1% by mass; or from 1% to 2% by mass; or from 2% to 3% by mass; or from 3% to 4% by mass; or from 4% to 5% by mass; or from 5% to 8% by mass; or from 8% to 12% by mass; or from 12% to 16% by mass; or from 16% to 20% by mass of the polyamide relative to the total mass of polyamide used in step i).

Step iii) is advantageously performed with stirring. For a given stirring system, the stirring speed allows the volume-mean diameter of the particles to be controlled. In general, as the stirring speed increases, the mean diameter of the polyamide particles reduces. Conversely, as the stirring speed reduces, the mean diameter of the polyamide particles increases.

### Step iv)

During the cooling step, when the precipitation temperature of the polyamide in said solvent is reached, a precipitation phase then begins. The start of this precipitation phase corresponds to the start of step iv) of the process according to the invention.

In step iv), the mixture is then maintained at a temperature close to this temperature (Tₚ) of precipitation of the polyamide in the solvent, at most equal to and notably within the range from −0.1° C. to −15° C. of this precipitation temperature, and this is maintained for a time sufficient to allow the production of a precipitated polyamide powder having a monomodal melting endotherm and an increased melting temperature.

In other words, the process includes in step iv) a temperature steady stage during which the temperature is kept constant for a period t. More particularly, the temperature is kept constant for the entire duration of the polyamide precipitation phase, namely a period t₁, and then for an additional period t₂ allowing the crystal lattice of the precipitated polyamide to be refined and thus to obtain a polyamide powder having a monomodal melting endotherm and an increased melting temperature.

In general, the duration t₁ is generally very much less than the duration t₂ so that the total duration t of the temperature steady stage is generally very close to t₂.

The additional time required to produce a monomodal melting endotherm may be determined by analyzing samples collected at different intervals using differential scanning calorimetry (DSC) according to the standard ISO11357-3.

By way of example, on conclusion of the phase of precipitation of polyamide 11, i.e. at the end of period t₁, the inventors were able to observe by DSC, on first heating, the production of a bimodal melting endotherm, characterized by two different melting temperatures. By keeping the temperature constant at a temperature close to the precipitation temperature of the polyamide in the solvent, for a sufficient additional time t₂, the inventors were able to observe the transformation of the bimodal melting endotherm of polyamide particles into a monomodal melting endotherm, reflected on the DSC thermogram by the disappearance of the peak associated with the lowest melting temperature, in favor of the peak associated with the highest melting temperature. Advantageously, this temperature steady stage of total duration t₁+t₂ thus allows both the T_{f1}−T_{c} difference to be increased and a monomodal melting endotherm to be obtained.

According to certain embodiments, in step iv), the mixture is kept at a constant temperature for a time t₂ of at least 2 hours, notably between 3 and 12 hours, preferably at least 4 hours, notably between 4 and 12 hours, with effect from the end of precipitation of the polyamide. This additional time after the end of the precipitation of the polyamide may be 2 to 3 hours; or 3 to 4 hours; or 4 to 5 hours; or 5 to 6 hours; or 6 to 7 hours; or 7 to 8 hours; or 8 to 9 hours; or 9 to 10 hours; or 10 to 11 hours; or 11 to 12 hours.

In certain embodiments, in step iv), the mixture is maintained at a constant temperature for a time t of at least 2 hours, notably between 3 and 12 hours, preferably at least 4 hours, notably between 4 and 12 hours, with effect from the start of precipitation of the polyamide. This time from the start of precipitation of the polyamide may be from 2 to 3 hours; or from 3 to 4 hours; or from 4 to 5 hours; or from 5 to 6 hours; or from 6 to 7 hours; or from 7 to 8 hours or from 8 to 9 hours; or from 9 to 10 hours; or from 10 to 11 hours; or from 11 to 12 hours.

### Steps v) and vi)

On conclusion of the temperature steady stage performed in step iv), the precipitated polyamide particles are recovered from the mixture in the form of a powder in step v) by conventional solid-liquid separation means.

This step generally involves cooling the mixture obtained so that the reactor can be drained and thus the precipitated polyamide particles obtained can be separated from the solvent, in particular by filtration.

The process for manufacturing the polyamide powder may also comprise a step vi) of drying the polyamide powder obtained in step iv) or recovered in step v). The drying step may be performed, for example, in an agitated or rotary dryer.

In certain embodiments, drying may be performed at a temperature of from 10° C. to 150° C., notably from 50° C. to 100° C., preferably from 25° C. to 85° C., and more preferentially from 70° C. to 80° C. The drying may, for example, be performed at a temperature of from 10° C. to 20° C.; or from 20° C. to 30° C.; or from 30° C. to 40° C.; or from 40° C. to 50° C.; or from 50° C. to 60° C.; or from 60° C. to 70° C.; or from 70° C. to 80° C.; or from 80° C. to 90° C.; or from 90° C. to 100° C.; or from 100° C. to 110° C.; or from 110° C. to 120° C.; or from 120° C. to 130° C.; or from 130° C. to 140° C.; or from 140° C. to 150° C.; or from 150° C. to 160° C.

In certain embodiments, the drying may be performed under vacuum at a pressure of less than 100 mbar, preferably less than 50 mbar. Thus, drying may be performed at a pressure of from 1 to 10 mbar; or from 10 to 20 mbar; from 20 to 30 mbar; from 30 to 40 mbar; from 40 to 50 mbar; from 50 to 60 mbar; from 60 to 70 mbar; from 70 to 80 mbar; from 80 to 90 mbar ; from 90 to 100 mbar; from 100 to 150 mbar; from 150 to 200 mbar; from 200 to 250 mbar; or from 250 to 300 mbar; or from 300 to 500 mbar; or from 500 to 700 mbar; or from 700 mbar to less than 1 bar (in absolute pressure).

As a variant, drying may be performed at atmospheric pressure.

Advantageously, drying of the organic solvent promotes the removal of any VOCs that may be present in the initial used composition.

### Step vii)

The particles recovered in step v), optionally dried in step vi), may optionally be subjected to a step vii) directed toward separating them from any inorganic materials, notably in the form of fillers, that may be present in the used polyamide composition engaged in step i).

As examples of mineral fillers that may be present in the used polyamide compositions, mention may be made of hollow beads, fibers, for example glass or carbon fibers, talc, carbon black, nanotubes, of carbon or otherwise.

The mineral fillers may be separated from the polyamide by exploiting the differences in density. By way of example, this separation may be performed by decantation, using cyclones etc.

The precipitated polyamide particles, separated from the mineral fillers by conventional means such as by decantation of the mixture from a suitable liquid, for example a mixture of water and glycerol, may be recovered on conclusion of step vii). They may optionally be dried under conditions similar to those of step v).

The polyamide powder and the mineral fillers may be recovered and reused separately.

Advantageously, the mineral fillers, such as the fibers, recovered on conclusion of step vii) are covered with crystallized polyamide, which makes them particularly compatible with a polymer matrix for use as a filler in a subsequent use.

Thus, according to certain embodiments, the invention relates to mineral fillers that can be obtained according to the recycling process described above, notably according to steps i) to vii).

According to other embodiments, the mineral fillers that may be present in the used polyamide composition may be separated and recovered before precipitation of the polyamide, notably before step iii). Specifically, during step i), the polyamide is generally dissolved in the solvent while the mineral fillers remain in suspension. They can then be separated out and recovered via conventional solid-liquid separation techniques, for instance by filtration.

### Polyamide Powder that may be Obtained According to the Recycling Process of the Invention

According to a second aspect, the invention relates to a polyamide powder having a monomodal melting endotherm and a single melting temperature (T_{f1}^{max}) which may be obtained via the recycling process as described above.

In certain embodiments, the polyamide powder has an inherent viscosity of from 0.8 to 1.7, and preferably from 1.0 to 1.5. Thus, for example, the powder may have an inherent viscosity of from 0.8 to 0.9; or from 0.9 to 1.0; or from 1.0 to 1.1; or from 1.1 to 1.2; or from 1.2 to 1.3; or from 1.3 to 1.4; or from 1.4 to 1.5; or from 1.5 to 1.6; or from 1.6 to 1.7. In the foregoing, the inherent viscosity is expressed in (g/100 g)⁻¹.

The inherent viscosity is measured using a micro-Ubbelohde tube. The measurement is taken at 20° C. on a 75 mg sample of powder at a concentration of 0.5% (m/m) in m-cresol. The inherent viscosity is expressed in (g/100 g)⁻¹ and is calculated according to the following formula:

Inherent viscosity=In(t₅/t₀)×1/C, with C=m/p×100, in which tₛ is the flow time of the solution, to is the flow time of the solvent, m is the mass of the sample whose viscosity is being determined and p is the mass of the solvent.

In certain embodiments, the precipitated polyamide powder may have a crystallization temperature (Tc) of from 100° C. to 200° C., and preferably from 130° C. to 180° C. The polyamide powder may in particular have a crystallization temperature of from 100° C. to 110° C.; or from 110° C. to 120° C.; or from 120° C. to 130° C.; or from 130° C. to 140° C.; or from 140° C. to 150° C.; or from 150° C. to 160° C.; or from 160° C. to 170° C.; or from 170° C. to 180° C.; or from 180° C. to 190° C.; or from 190° C. to 200° C.

In certain embodiments, the polyamide powder has a heat of fusion of greater than or equal to 60 J/g, preferably greater than or equal to 100 J/g. This heat of fusion may be, for example, from 60 to 80 J/g; or from 80 to 100 J/g; or from 100 to 110 J/g; or from 110 to 120 J/g; or from 120 to 130 J/g; or from 130 to 140 J/g; or from 140 to 150 J/g; or from 150 to 160 J/g. In certain embodiments, the polyamide powder may have a melting temperature Tf₁ of between 130° C. and 260° C., and preferably of between 160° C. and 210° C. In particular, the polyamide powder may have a melting temperature of from 130° C. to 140° C.; or from 140° C. to 150° C.; or from 150° C. to 160° C.; or from 160° C. to 170° C.; or from 170° C. to 180° C.; or from 180° C. to 190° C.; or from 190° C. to 200° C.; or from 200° C. to 210° C.; or from 210° C. to 220° C.; or from 220° C. to 230° C.; or from 230° C. to 240° C.; or from 240° C. to 250° C.; or from 250° C. to 260° C.

The melting temperature (Tf₁) of the precipitated polyamide powder is determined during the first heating as explained previously. According to the process of the invention, a single melting temperature of the polyamide is observed on conclusion of the temperature steady stage at the end of step iv).

In certain embodiments, the polyamide powder may have an apparent specific surface area of from 0.1 to 50 m²/g, and preferably from 1 to 10 m²/g. The precipitated polyamide powder may thus have a specific surface area of from 0.1 to 1 m²/g; or from 1 to 5 m ²/g; or from 5 to 10 m²/g; or from 10 to 20 m²/g; or from 20 to 30 m²/g; or from 30 to 50 m²/g. The apparent specific surface area (SSA) is measured according to the BET (Brunauer-Emmett-Teller) method, known to those skilled in the art. It is notably described in the Journal of the American Chemical Society, volume 60, page 309, February 1938, and corresponds to the international standard ISO 9277: 2010. The specific surface area measured according to the BET method corresponds to the surface porosity of the powder, i.e. it includes the area formed by the pores at the surface of the particles.

According to certain embodiments, the polyamide powder obtained according to the process of the invention is characterized in that it has:
a volume-mean diameter of between 10 and 200 μm, notably between 20 and 100 μm, and preferentially between 40 and 80 μm;
a diameter Dv10 of greater than 5 μm, notably between 10 and 70 μm, and preferentially between 20 and 60 μm;
a volume-median diameter Dv50 of between 10 and 200 μm, notably between 20 and 100 μm, and preferentially between 30 and 90 μm;
a diameter Dv90 of less than 350 μm, notably between 30 and 200 μm, and preferentially between 50 and 150 μm;
a span factor of between 0.1 and 1.5; and preferentially between 0.5 and 1.0;
an enthalpy of fusion of greater than 60 J/g; and preferentially between 100 and 160 J/g;
an inherent viscosity of between 0.5 and 2.0, and preferentially between 1.0 and 1.5.

In a preferred embodiment, the polyamide powder with a monomodal melting endotherm and a single melting temperature (T_{f1}^{max}) that may be obtained by the recycling process is characterized in that it has a span factor of between 0.1 and 1.5, preferably between 0.1 and 1.0 and more preferentially between 0.5 and 1.0.

### Polyamide 11 Powder

According to another aspect, the invention relates to a polyamide 11 powder characterized in that it has a monomodal melting endotherm and a single melting temperature on first heating T_{f1} equal to Tf₁^{max} of between 195° C. and 205° C., notably of about 200° C., and/or a crystallization temperature Tc of between 150° C. and 165° C., notably of about 158° C.

Polyamide 11 powder is notably a powder characterized by one or more of the following features, preferably by all of the following features:
a volume-mean diameter of between 10 and 200 μm, notably between 20 and 100 μm, and preferentially between 40 and 80 μm;
a diameter Dv10 of greater than 5 μm, notably between 10 and 70 μm, and preferentially between 20 and 60 μm;
a volume-median diameter Dv50 of between 10 and 200 μm, notably between 20 and 100 μm, and preferentially between 30 and 90 μm;
a diameter Dv90 of less than 350 μm, notably between 30 and 200 μm, and preferentially between 50 and 150 μm;
a span factor of between 0.1 and 1.5; and preferentially between 0.5 and 1.0;
an enthalpy of fusion of greater than 100 J/g; and preferentially between 110 and 160 J/g;
an inherent viscosity of between 0.8 and 1.8, and preferentially between 1.0 and 1.5.

Preferably, the polyamide 11 powder is characterized in that it has a monomodal melting endotherm and a single melting temperature on first heating Tn equal to Tf₁^{max} of between 195° C. and 205° C., and a span factor of between 0.1 and 1.5, preferentially between 0.1 and 1 and more preferentially between 0.5 and 1.0.

### Composition in Powder Form for 3D Printing, Notably by Selective Laser Sintering

According to yet another aspect, the invention relates to a composition in powder form for 3D printing, notably by selective laser sintering, comprising a polyamide powder as defined above, in combination with one or more usual fillers or additives, i.e. suitable for 3D printing technologies.

This composition is advantageously ready to use.

This composition may comprise additives which help to improve the transformation properties of the powder for its use as a function of the 3D printing technologies.

The additives generally represent less than 5% by weight, relative to the total weight of the composition. Preferably, the additives represent less than 1% by weight relative to the total weight of the composition. Among the additives, mention may be made of flow agents, stabilizers (light, in particular UV, and heat stabilizers), optical brighteners, dyes, pigments and energy-absorbing additives (including UV absorbers).

Among the flow agents, mention may be made, for example, of a hydrophilic or hydrophobic silica. Advantageously, the flow agent represents from 0.01% to 0.5% by weight, relative to the total weight of composition. Preferably, the composition includes from 0.1% to 0.4% by weight of flow agent.

The composition may also comprise one or more fillers, notably allowing the mechanical properties (breaking stress and elongation at break) of the parts obtained by 3D printing to be improved.

The fillers generally represent less than 50% by weight and preferably less than 40% by weight, relative to the total weight of final powder. Among the fillers, mention is made of reinforcing fillers, notably mineral fillers such as carbon black, talc, carbon or non-carbon nanotubes, fibers (glass, carbon, etc.), which may or may not be milled.

The additives or fillers may be mixed with the polyamide before the polyamide powder manufacturing process, during the polyamide powder manufacturing process (for example, in step i) before dissolution of the polyamide or in step iv) after precipitation), or after the polyamide powder manufacturing process. Preferably, the additives are introduced after the polyamide powder manufacturing process, by mixing between the polyamide powder and said additives.

The composition may comprise the polyamide in a weight proportion preferably greater than or equal to 80%, or 81%, or 82%, or 83%, or 84%, or 85%, or 86%, or 87%, or 88%, or 89%, or 90%, or 91%, or 92%, or 93%, or 94%, or 95%, or 96%, or 97%, or 98%, or 99%, or 99.1%, or 99.2%, or 99.3%, or 99.4%, or 99.5%, or 99.6%, or 99.7%, or 99.8%, or 99.9%, or 99.91%, or 99.92%, or 99.93%, or 99.94%, or 99.95%, or 99.96%, or 99.97%, or 99.98%, or 99.99%.

In certain embodiments, the polyamide contained in the composition is polyamide 11.

In certain embodiments, the polyamide 11 has a melting temperature (T_{f1}) of between 185° C. and 205°.

In certain embodiments, the difference between the melting temperature (T_{f1}) and the crystallization temperature (T_{c}) of the polyamide 11 is between 35 and 45° C.

### Use of a Polyamide Powder Obtained According to the Recycling Process of the Invention or of a Composition in Powder Form Comprising Same, in a Process of Powder Agglomeration by Fusion

A subject of the invention is also a process for manufacturing a polyamide object by powder agglomeration via electromagnetic radiation-mediated fusion, the powder being a polyamide powder or a composition in powder form as defined previously.

The electromagnetic radiation may be infrared, ultraviolet or visible radiation. Preferably, it is laser radiation (the manufacturing process is then known as “selective laser sintering”).

According to this process, a thin layer of powder is deposited on a horizontal plate maintained in a chamber heated to a temperature called the build temperature. The term “build temperature” denotes the temperature to which the bed of powder, of a constituent layer of a three-dimensional object under construction, is heated during the process of layer-by-layer sintering of the powder. This temperature is chosen within the T_{f1}−T_{c} range of the polyamide powder resulting from the manufacturing process, preferably between T_{f1} −5° C. and T_{c} +5° C., and more preferentially between T_{f1} −10° C. and T_{c} +10° C. The electromagnetic radiation then provides the energy required to sinter the powder particles at different points in the powder layer according to a geometry corresponding to an object (for example using a computer containing in its memory the shape of an object and reproducing this shape in the form of slices).

The horizontal plate is then lowered by a distance corresponding to the thickness of a layer of powder, and a new layer is deposited. The thickness of a layer is typically between 0.05 and 2 mm, and generally of the order of 0.1 mm. The electromagnetic radiation provides the energy required to sinter the powder particles into a geometry corresponding to this new slice of the object, and so on. The procedure is repeated until the object is manufactured. Powders are used in the agglomeration process by fusion or sintering. These powders may have a volume-mean diameter of from 10 μm to 200 μm and advantageously have a volume-mean diameter of between 20 and 100 μm.

Preferably the volume-mean diameter is between 40 and 80 μm.

The invention also relates to a manufactured article, notably made by 3D printing, obtained by electromagnetic radiation-mediated sintering of a powder as described previously.

This article may be chosen from prototypes and models, notably in the automotive, nautical, aeronautical, aerospace, medical (prostheses, hearing systems, cellular tissues, etc.), textile, clothing, fashion, decorative, electronic, telephony, home automation, IT and lighting fields. More generally, the invention also relates to the use of a manufacturing process as described previously for increasing the difference (T_{f1}−T_{c}) between the melting temperature (T_{f1}) and the crystallization temperature (T_{c}) of a polyamide.

### EXAMPLES

The examples that follow illustrate embodiments of the present invention without, however, limiting it.

In all the examples that follow:
the particle size of the powders was characterized by measuring the particle size distribution on a Coulter Counter-Multisizer 3 device (Beckmann Coulter) in accordance with the standard ISO 13319-1: 2021. From this, the volume-mean diameter and the diameters Dv10, Dv50 and Dv90 were determined. The span value is calculated from these volume-mean diameters.
the analysis of the thermal characteristics is made by DSC according to the standard ISO 11357-3 “Plastics—Differential Scanning Calorimetry (DSC) Part 3: Determination of temperature and enthalpy of melting and crystallization”. The temperatures that are more particularly of concern herein are the first-heating melting temperature (T_{f1}) and the crystallization temperature (T_{c}). Specifically, in a manner known to those skilled in the art (in the field of manufacturing 3D objects by powder agglomeration by fusion), the difference “T_{f}−T_{c}” corresponds to T_{f1}−T_{c}.
the inherent viscosity of the polyamides is measured in an Ubbelohde-type viscometer according to the standard ISO 307: 2019, except when using m-cresol as the solvent and a temperature of 20° C.
the acidity (which may be regarded as the concentration of COOH chain ends of the polyamide) and the basicity (which may be regarded as the concentration of NH₂ chain ends of the polyamide) are measured potentiometrically. The acidity is measured according to the following method: a sample of polyamide is dissolved in benzyl alcohol at a concentration of 0.6% by mass; and this sample is then assayed potentiometrically using a 0.02 N tetrabutylammonium hydroxide solution. The basicity is measured according to the following method: a polyamide sample is dissolved in meta-cresol at a concentration of 0.6% by mass; and this sample is then assayed potentiometrically using a 0.02 N perchloric acid solution.

### Example 1 According to the Invention: Recycling of a Used Polyamide Composition Containing Glass Fibers

Scraps and cores recovered following injection of the Rilsan® BZM30 O TLDA grade were first coarsely crushed so that they could be handled more easily. Their composition is as follows: 70 wt % of partially oxidized PA11 and 30 wt % of glass fibers (and residual antioxidants). 85 g of this crushed starting material and 425 g of technical-grade ethanol (96% purity) are loaded into a reactor (1 L working volume), with mechanical stirring performed using an impeller-type turbomixer. The stirrer is run at a speed of 500 rpm throughout the test, and the medium is then heated to 160° C., followed by a one-hour isotherm to dissolve only the used polyamide. Controlled cooling at a rate of −60° /h down to 110° C. is performed to precipitate the polyamide, followed by a 4-hour isotherm at this same temperature to effect crystal refinement. The crystallization exothermicity is detected at 115° C. and only disrupts the thermal control for a few minutes. The precipitation temperature is 115° C. Controlled cooling is then restarted at this same rate of −60° /h down to 20° C., the reactor is then drained and the dispersion is dried in an oven at 75° C. at atmospheric pressure.

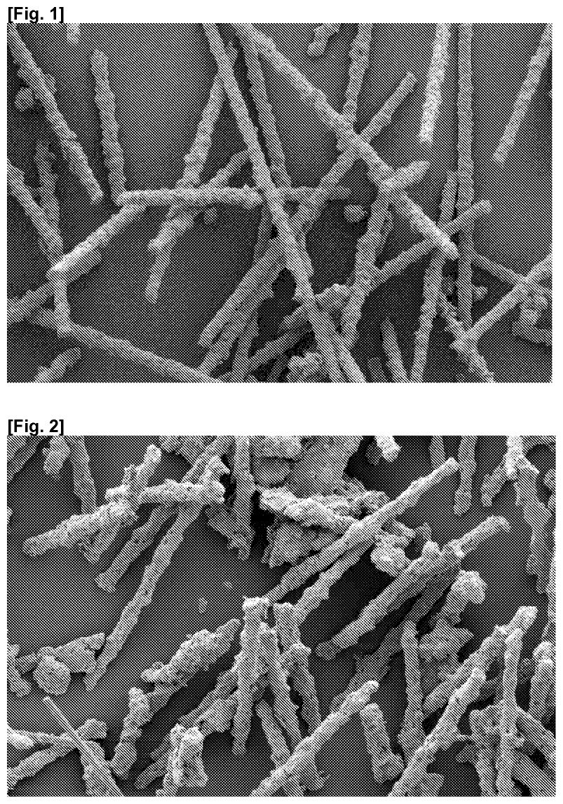

It was possible to separate the used PA11 powder from the glass fibers by decantation, using a water/glycerol mixture (45/55% by volume). It is then seen that 61% by mass of the used PA11 precipitated directly in the form of a powder and the remaining 39% by mass allowed the glass fibers to be coated (Cf. FIG. 1). The glass fibers, precoated with PA11, are more readily incorporated and have better compatibility with polyamide matrices than natural glass fiber. In addition to being able to be recycled, these glass fibers are now more readily usable in polyamide-based compositions.

The PA11 powder obtained has the following features: an inherent viscosity of 1.30, a volume-mean diameter of 61 μm and also diameters Dv10=29 μm, Dv50=68 μm and Dv90 =91 μm, thus a span =0.91. DSC analysis of this PA11 powder shows a monomodal melting endotherm on first heating with a single melting temperature of 201° C. associated with an enthalpy of fusion of 136 J/g, and also a single crystallization temperature T_{c}=158° C. The difference Tf₁−T_{c} is now equal to 43° C.

### Example 2 According to the Invention: Recycling of a Used Polyamide Composition Containing Carbon Fibers

Scraps and cores recovered following injection of the Rilsan® BSR30 grade were first coarsely crushed so that they could be handled more easily. Their composition is as follows: 70 wt % of partially oxidized PA11 and 30 wt % of carbon fibers (and residual antioxidants and carbon black).

85 g of this crushed starting material and 425 g of technical-grade ethanol (96% purity) are loaded into a reactor (1 L working volume), with mechanical stirring performed using an impeller-type turbomixer. The stirrer is run at a speed of 500 rpm throughout the test, and the medium is then heated to 160° C., followed by a one-hour isotherm to dissolve only the partially oxidized polyamide. Controlled cooling at a rate of −60° C./h down to 110° C. is performed to precipitate the polyamide, followed by a 4-hour isotherm at this same temperature to effect crystal refinement. The crystallization exothermicity is detected at 115° C. and only disrupts the thermal control for a few minutes. The precipitation temperature is 115° C. Controlled cooling is then restarted at this same rate of −60° C./h down to 20° C., the reactor is then drained and the dispersion is dried in an oven at 75° C. at atmospheric pressure.

It was possible to separate the used PA11 powder from the carbon fibers by decantation using a water/glycerol mixture (45/55% by volume). It is then seen that 52% by mass of the partially oxidized PA11 precipitated directly in the form of a powder and the remaining 48% by mass allowed the carbon fibers to be coated (Cf. FIG. 2). The carbon fibers, precoated with PA11, are more readily incorporated and have better compatibility with polyamide matrices than natural carbon fiber. In addition to being able to be recycled, these fibers are now more readily usable in polyamide-based compositions.

The PA11 powder obtained has the following features: it is black in color (the carbon black has not been separated out), it has an inherent viscosity of 1.42, a volume-mean diameter of 55 μm and also diameters Dv10=29 μm, Dv50=58 μm and Dv90=77 μm, thus a span=0.83. DSC analysis of this PA11 powder shows a monomodal melting endotherm on first heating with a single melting temperature of 200° C. associated with an enthalpy of fusion of 132 J/g, and also a single crystallization temperature T_{c}=159° C. The difference Tf₁−T_{c} is now equal to 42° C.

### Example 3 According to the Invention: Recycling of a Used Polyamide Composition Contaminated with VOCs

Used pipes were collected from fuel lines during the dismantling of various vehicles. These pipes were originally obtained by extrusion of Rilsan® BESN Black P20 TL. They were first coarsely crushed to make them easier to handle. These used PA11 pipes contain 4% by mass of VOCs (mainly petroleum spirit, toluene, xylene and tri-methylbenzene). The content is determined by thermogravimetric analysis and the composition by gas chromatographic analysis.

85 g of this crushed starting material and 425 g of technical-grade ethanol (96% purity) are loaded into a reactor (1 L working volume), with mechanical stirring performed using an impeller-type turbomixer. The stirrer is run at a speed of 500 rpm throughout the test, and the medium is then heated to 160° C., followed by a one-hour isotherm to dissolve only the partially oxidized polyamide. Controlled cooling at a rate of −60° C./h down to 115° C. is performed to precipitate the polyamide, followed by a 4-hour isotherm at this same temperature to effect crystal refinement. The crystallization exothermicity is detected at 120° C. and only disrupts the thermal control for a few minutes. The precipitation temperature is 120° C. Controlled cooling is then restarted at this same rate of −60° C./h down to 20° C., the reactor is then drained and the dispersion is dried at 90° C. under vacuum (50 mbar) for 6 hours.

The VOC content of the PA11 powder is now 0.35% by mass (mainly consisting of ethanol with traces of pollutants <0.1% by mass). The process of dissolution in/precipitation from ethanol thus seems capable of extracting the pollutants from the PA11 and then eliminating them via entrainment during the vacuum drying.

The PA11 powder obtained has the following features: it is black in color (the carbon black has not been separated out), it has an inherent viscosity of 1.45, a volume-mean diameter of 51 μm and also diameters Dv10=25 μm, Dv50=49 μm and Dv90=62 μm, thus a span=0.76. DSC analysis of this PA11 powder shows a monomodal melting endotherm on first heating with a single melting temperature of 199° C. associated with an enthalpy of fusion of 136 J/g, and also a single crystallization temperature T_{c}=159° C. The difference Tf₁−T_{c} is now equal to 40° C.

### Example 3a (Comparative): Removal of VOCs From a Used Composition by Drying

The same crushed starting material as in Example 3 was placed directly in a dryer so as to extract the VOCs from the PA11. After 12 hours of drying at 90° C. under vacuum at 50 mbar, it was only possible to remove 0.5% by mass of these VOCs. It was necessary to heat the dryer at 150° C. for a further 12 hours under vacuum at 50 mbar in order to remove 3.5% by mass of the VOCs. The crushed PA11 powder thus obtained still contains a residual VOC content of 0.5% by mass. Moreover, its particle size makes it unsuitable for use in 3D printing. In addition to recovering a powder that may be used directly in 3D printing, the drying of Example 3 according to the invention advantageously requires less energy to eliminate the VOCs.

### Example 4 (Comparative) According to US 2008/0166496

A diamine-terminated PA11 is prepared by polymerization of 250 g of 11-aminoundecanoic acid in the presence of 1.25 g of 4,4′-diaminocyclohexylmethane (PACM, mixture of isomers). The polyamide 11 obtained has an inherent viscosity of 1.42 in combination with a concentration of chain-end COOH groups equal to 19 mmol/kg and of chain-end NH₂ groups equal to 67 mmol/kg.

85 g of this diamine-terminated PA11 and 425 g of technical-grade ethanol (purity 96%) are loaded into a reactor (1 L working volume), with mechanical stirring performed using an impeller-type turbomixer. The stirrer was run at a speed of 500 rpm throughout the test. The medium was heated to 152° C., followed by a one-hour isotherm at this temperature. The medium was then cooled to 112° C. at a rate of 25° C./h and then maintained at this temperature for one hour. During this cooling phase, when the internal temperature reached 125° C., the jacket temperature had to be 2 to 3° C. lower than the internal temperature. Crystallization exothermicity is detected and only disrupts the controlled cooling for a few minutes. After one hour at this temperature, the medium is cooled to room temperature. The reactor is then drained and the ethanol is distilled off in an agitated dryer at 70° C./400 mbar and the powder is then dried at 84° C./20 mbar.

The PA11 powder obtained has the following particle size features: a volume-mean diameter of 89 μm and also diameters Dv10=65 μm, Dv50=93 μm and Dv90=123 μm, thus a span =0.62. DSC analysis of this PA11 powder shows a bimodal melting endotherm on first heating with a shoulder at 193° C. and a peak at 202° C. associated with an enthalpy of fusion of 140 J/g, and also a single crystallization temperature T_{c}=162° C. The lower of the two melting temperatures is used to calculate the difference T_{f1}−T_{c}, which is thus equal to 29° C.

1. A process for recycling a used polyamide composition into a recycled polyamide powder having a monomodal melting endotherm and a single melting temperature (T_{f1}^{max}), said process comprising the steps of:
i. placing a used polyamide composition in contact with a solvent so as to obtain a mixture;
ii. heating the mixture so as to dissolve the polyamide in the solvent;
iii. cooling the mixture to the precipitation temperature (Tₚ) of the polyamide in said solvent, thereby obtaining a precipitated polyamide powder characterized by a non-monomodal melting endotherm and more than one melting temperature, (T_{f1}^{max}) being the highest melting temperature; and
iv. maintaining the temperature of the mixture at a temperature at most equal to Tₚ, until the precipitated polyamide powder is characterized by a monomodal melting endotherm and a melting temperature (T_{f1}^{max}); and
v. recovery of the recycled polyamide powder obtained.

2. The process as claimed in claim 1, in which the solvent which is placed in contact with the polyamide is an alcohol.

3. The process as claimed in claim 1, in which the polyamide is polyamide 11, polyamide 6, polyamide 10.10, polyamide 10.12, or polyamide 6.10.

4. The process as claimed in claim 1, in which, in step iv), the mixture is maintained at a temperature for a time of at least 2 hours, with effect from the end of precipitation of the polyamide.

5. The process as claimed in claim 1, in which the composition also comprises volatile organic compounds (VOCs).

6. The process as claimed in claim 1, in which the composition comprises mineral fillers.

7. The process as claimed in claim 6, also comprising a step vii) of separating out and recovering the mineral fillers that may be present in the precipitated polyamide powder.

8. A polyamide powder with a monomodal melting endotherm and a single melting temperature (T_{f1}^{max}) which may be obtained via the recycling process as claimed in claim 1.

9. The polyamide powder as claimed in claim 8, wherein the powder has a span factor of between 0.1 and 1.5.

10. The powder as claimed in claim 8, in which the polyamide is polyamide 11.

11. The powder as claimed in claim 9, in which the difference between the melting temperature (T_{f1}^{max}) and the crystallization temperature (T_{c}) is between 35 and 45° C.

12. The polyamide 11 powder as claimed in claim 8, having a monomodal melting endotherm and a single melting temperature (T_{f1}^{max}) of between 195° C. and 205° C., also having at least one of the following features:
a volume-mean diameter of between 10 and 200 μm;
a diameter Dv10 of greater than 5 μm;
a volume-median diameter Dv50 of between 10 and 200 μm;
a diameter Dv90 of less than 350 μm;
a span factor of between 0.1 and 1.5;
an enthalpy of fusion of greater than 100 J/g; and
an inherent viscosity of between 0.8 and 1.8.

13. A composition in powder form for 3D printing, comprising:
a polyamide powder as claimed in claim 8; and
at least one filler or additive.

14. A process for manufacturing polyamide objects by powder agglomeration via electromagnetic radiation-mediated fusion, the powder being as defined in claim 8.

15. A manufactured article obtained by electromagnetic radiation-mediated fusion of a powder as claimed in claim 8.

16. A mineral filler which may be obtained according to the recycling process as claimed in claim 6.

17. The mineral filler as claimed in claim 16, precoated with a polyamide powder having a monomodal melting endotherm and a single melting temperature.
